(19) United States
(12) Patent Application Publication
(10) Pub. No.: US 2009/0206665 A1
(43) Pub. Date: Aug. 20, 2009

(54) APPARATUS FOR CONTROLLING ELECTRICAL POWER DISTRIBUTION BETWEEN A PRIMARY DEVICE AND AT LEAST ONE SECONDARY DEVICE

(76) Inventors: Bruce Barton, Huntington, NY (US); Russell Barton, Northport, NY (US)

Correspondence Address: EDWIN D. SCHINDLER, FIVE HIRSCH AVENUE, P.O. BOX 966, CORAM, NY, 11727-0966, US

(21) Appl. No.: 12/033,561

(22) Filed: Feb. 19, 2008

(51) Int. Cl. H02J 1/00

(52) U.S. Cl. 307/39

(57) ABSTRACT

An apparatus for controlling a power distribution to subsystems includes a power input that is to be connected to a power source and a primary power output to be connected to a primary device, along with at least one secondary power output, which is to be connected to at least one secondary device. A sensing device is included for sensing when a current level falls below a first predetermined threshold, in response to the primary device being turned off, deactivated or “on standby,” as well as for sensing when the current level rises above a second predetermined threshold in response to the primary device being turned “on” or activated. An executing device is connected with the sensing device and is operative for interrupting a power supply to, at least, one secondary device when the sensing device senses that the current level has fallen below the threshold. Alternatively, the executing device is able to supply power to one or more secondary devices when the sensing device senses that the current level is above the threshold.

### BACKGROUND OF THE INVENTION

1. Technical Field of the Invention

The present invention relates, generally, to an apparatus for controlling a distribution of electrical power to subsystems, e.g., to a primary device and at least one secondary device.

More particularly, the present invention relates to an apparatus for controlling a distribution of power formed as an electrical power strip and power control sensors, which can be used with new devices having a plurality of modes of operation, e.g., standby or “off” and full “on,” with the use of a primary device or secondary devices.

2. Description of the Prior Art

One type of an electrical distribution device known to the art is the power strip or power control center, which generally comprises of a row of power outlets, that can be either switched or unswitched, for distributing power to a primary device and one or more secondary devices from a standard outlet (e.g., wall outlet). Some of these known power strips and control centers contain various options, such as, circuit breakers, fuses and/or surge protectors.

In many newer personal computer systems, the system can shut itself “off” upon command from the operating system. During system shutdown, there is a delay during which the operator must wait for the personal computer system to complete its shutdown before proceeding to separately turn off secondary devices, such as printers and monitors. Depending upon the operating software and application programs, this waiting period can be significant. The present invention, as detailed hereinafter, proceeds to turn off the secondary, or peripheral, devices after a user directs the operating system of the computer system to commence shutdown of the computer; the user not being required to await shutdown of the computer before proceeding to separately turn off the secondary devices.

Known to the prior art are various devices and methods for controlling the operation of secondary devices, as broadly disclosed in U.S. Pat. No. 4,731,549; U.S. Pat. No. 4,825,140; and U.S. Pat. No. 4,970,623. The apparatuses and methods taught by the foregoing prior art patents all require internal power supplies and numerous components, rendering each too expensive for mass production and difficult to connect to in a standard power strip. Such devices also use standby power, inasmuch as an internal power supply is always on.

Various improvements over the devices disclosed and suggested by the foregoing references are disclosed in the inventors' U.S. Pat. No. 6,501,195; U.S. Pat. No. 6,528,902; U.S. Pat. No. 6,759,762; U.S. Pat. No. 6,759,763; and P.C.T. Application Publication No. WO 2006/022632.

### SUMMARY OF THE INVENTION

It is, therefore, an object of the present invention to provide an apparatus for controlling the distribution of electrical power to secondary subsystems, for example, computer peripheral devices, that allows, e.g., for an automated shutdown or switch to a “standby” mode of the secondary subsystems, once a shutdown of the primary system has been undertaken.

It is a further object of the present invention to provide an apparatus for controlling the distribution of electrical power to secondary subsystems that overcomes the inherent drawbacks of the prior art.

The foregoing and related objects are accomplished by the present invention, which provides an apparatus for controlling a power distribution to subsystems that includes a power input that is to be connected to a power source and a primary power output to be connected to a primary device, along with at least one secondary power output, which is to be connected to at least one secondary device. Means for sensing is included for sensing when a current level falls below a first predetermined threshold, in response to the primary device being turned off, deactivated or “on standby,” as well as for sensing when the current level rises above a second predetermined threshold in response to the primary device being turned “on” or activated. Executing means is connected with the sensing means and operative for interrupting a power supply to, at least, one second-ary device when the sensing means senses that the current level has fallen below the threshold; the executing means is able to supply power to one or more secondary devices when the sensing means senses that the current level is above the threshold.

Low current operating means is included for increasing the voltage required for triggering the executing means, despite there being a relatively small output of the sensing means, with the lower current operating means being capable of increasing the voltage of the executing means without negatively affecting the sensing means. The low current operating means, in a preferred embodiment, uses a voltage reference for preventing a triggering level change with source voltage changes.

Also in accordance with the present invention, a low current operating voltage increasing means includes a voltage divider or voltage reference means.

In accordance with a further embodiment of the present invention, the sensing means can be formed as a current sensing coil or transformer arranged to the input of the triggering device and, at one side, connected to the voltage increasing means.

The executing means can, for example, be formed as a DC relay, an AC relay or as a solid state AC relay. Alternative relay devices operative with the present invention can be readily determined by those skilled in the art.

When the present invention is used in connection with a computer system, each secondary device is plugged into a separate outlet with the primary computer device being plugged into a primary outlet. When the computer is turned on, the current level would increase to a sufficient level to turn on the secondary device(s). Other constant power outlets may also be included for wake-up devices, such as modems capable of bringing the system out of “standby” mode.

Other objects and features of the present invention will become apparent when considered in combination with the accompanying drawing figures which illustrate certain preferred embodiments of the present invention. It should, however, be noted that the accompanying drawing figures are intended to illustrate only certain embodiments of the claimed invention and are not intended as a means for defining the limits and scope of the invention.

### BRIEF DESCRIPTION OF THE DRAWING FIGURES

In the drawing, wherein similar reference numerals and symbols denote similar features throughout the several views:

FIG. 1 is a view showing circuitry for an apparatus for controlling power distribution to subsystems in accordance with a preferred embodiment of the present invention;

FIGS. 2-5 are views showing circuitry for the inventive apparatus in accordance with a further preferred embodiment of the present invention; and,

FIGS. 6 and 7 are views showing circuitry for the inventive apparatus in accordance with still an additional, preferred, embodiment of the present invention.

### DETAILED DESCRIPTION OF THE PREFERRED EMBODIMENTS AND DRAWING FIGURES

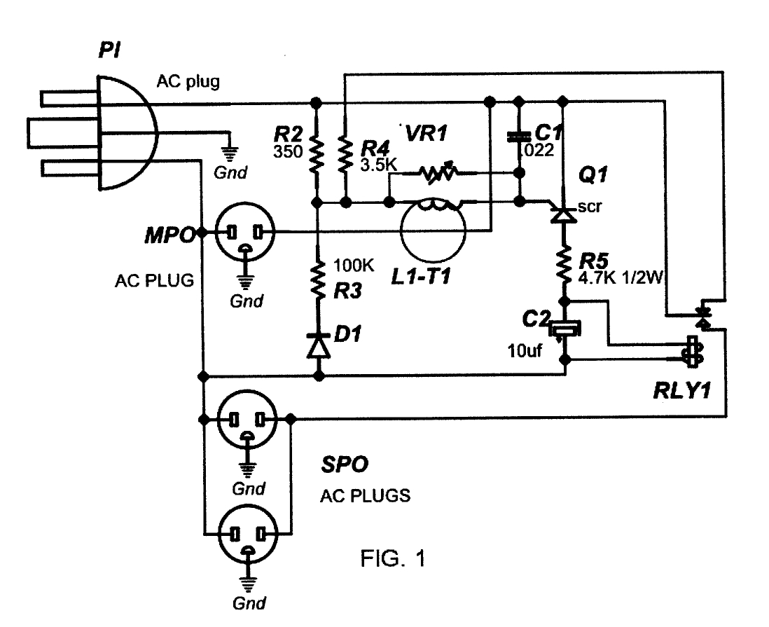

An apparatus for distributing power to subsystems in accordance with a first embodiment of the present invention, as shown in FIG. 1, has a power input (PI), which is connectable to an AC power source. A current sensing coil, or transformer (L1-T1), converts the current drawn by a main system or device connected to a main power output (MPO), into a voltage.

A voltage divider is formed by two resistors (R2 and R3), so that a small voltage is formed across the bias resistor (R2). This voltage is sufficiently small so as not to trigger the gate of the SCR (Q1). The resistors (R2 and R3) form means for increasing the voltage to provide triggering of the executing means despite the small output of the current sensing coil (L1-T1).

The bias resistor (R2) and the capacitor (C1) form a time constant to filter out line noise and prevent false triggering of the SCR (Q1).

When the voltage across the current sensing coil, created by the main device power level, plus the voltage across the bias resistor (R2), exceeds the gate trigger voltage of the SCR (Q1), the SCR (Q1) will switch on. Current then flows through the SCR (Q1), current limiting resistor (R5), to charge the capacitor (C2). The current limiting resistor (R5) limits the current to the SCR (Q1), as well as forming a resistive capacitive time constant to slow down the charging the capacitor (C2). This helps prevent false triggers, as well as creating a turn on time delay for one or more secondary systems, if desired.

The energy now stored in capacitor (C2) turns on a relay (RLY1) to control power supply to secondary power outputs (SPO), to which one or more of the secondary system devices are connected.

A hysteresis resistor (R4) is used to lower the voltage across the bias resistor (R2) when the relay (RLY1) is off. When the relay is on, one side of the hysteresis resistor (R4) is disconnected, increasing the voltage across the bias resistor (R2). This prevents oscillation of the relay (RLY1) if the main device power level is close to the threshold of the sensing means.

A diode (D1) is used to lower the power used by the voltage divider resistors (R2 and R3), but is not required.

In the foregoing embodiment, the current sensing coil or transformer (L1-T1), together with the bias resistor (R2) and the SCR (Q1), constitute sensing means which sense a current level that is either below, or above, a predetermined threshold. The relay constitutes executing means which, in response to the sensing of the current level by the sensing means, interrupts the current supply to the secondary device(s), when the sensed level is below the threshold as a result of turning off the primary device, or supplies the current to the secondary device(s), when the current level sensed by the sensing means is above the threshold, as a result of turning on the primary device.

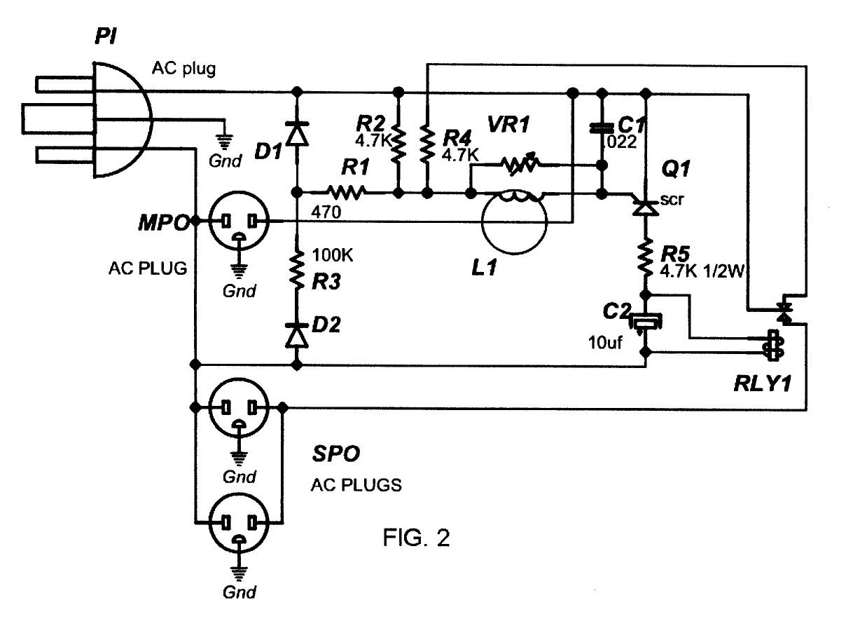

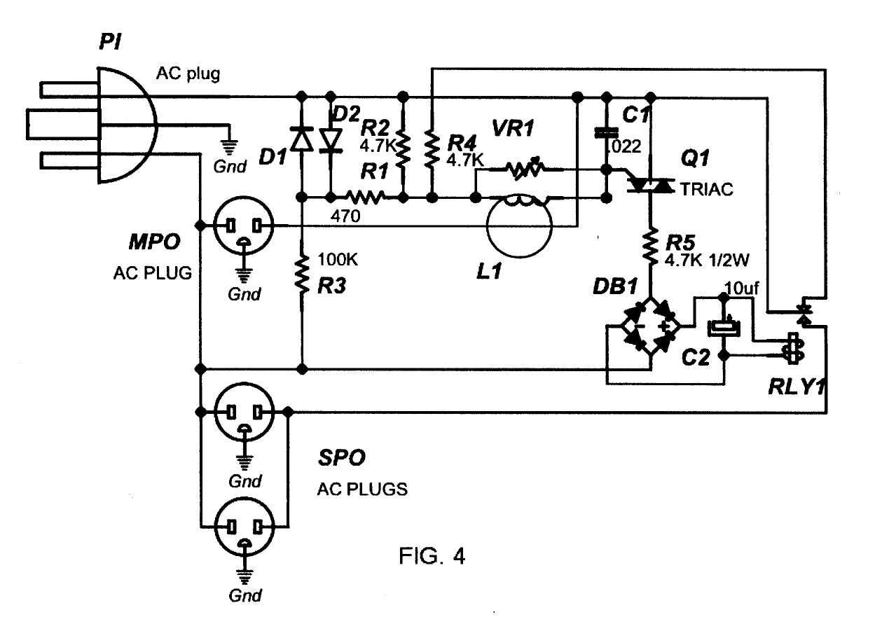

FIG. 2 shows another embodiment of the apparatus in accordance with the present invention. In this alternatively preferred embodiment, the voltage divider resistors (R1 and R2) are now feed by the voltage reference formed by the diode (D1) and the resistor (R3). The resistor (R3) feeds a small current though the diode (D1) to create a 0.6-volt reference during a half cycle on the incoming AC power source. Another diode (D2) is used to protect the SCR (Q1) from reverse bias damage. The diode (D2) can also be placed, as in FIG. 4, to protect the SCR (Q1), however, this would result in four times the power being used by the resistor (R3).

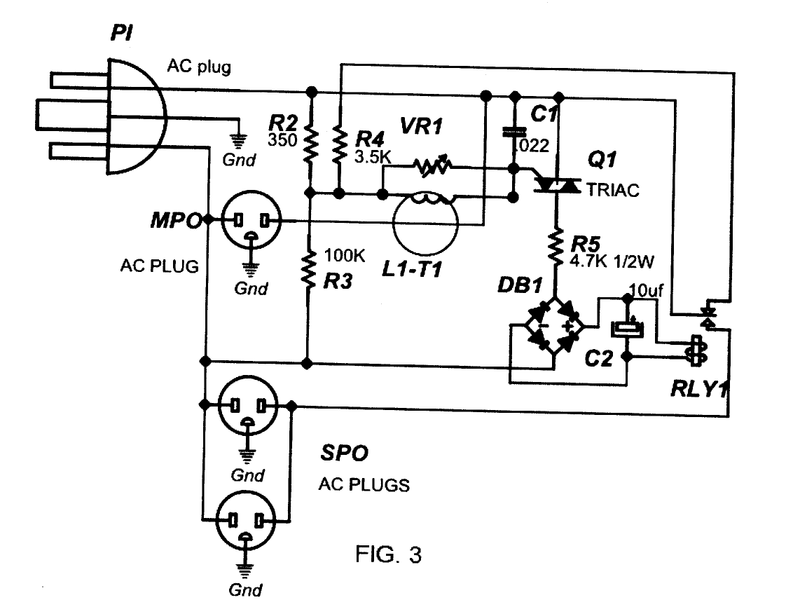

FIG. 3 shows a further embodiment of the present invention, which substantially corresponds to the embodiment of FIG. 1. However, in the apparatus in accordance with the embodiment of FIG. 3, the triggering device SCR (Q1) has been replaced by a triac (Q1). Additionally, the diode (D1) has been removed, because the triac (Q1) requires biasing for the two halves of the AC cycle. If a DC relay is used, a rectifier becomes necessary. In FIG. 3, a bridge rectifier (DB1) is designated for use.

FIG. 4 shows an additional embodiment of the inventive apparatus, which substantially corresponds to the embodiment of FIGS. 2 and 3. However, in the apparatus in accordance with the embodiment of FIG. 4, the triggering device SCR (Q1) of FIG. 2 has been replaced by a triac (Q1). Furthermore, the diode (D2) has been removed and, instead, placed opposite and parallel to the diode (D1) to form a reference for both halves of the AC cycle. Again, if a DC relay is used, a rectifier becomes necessary. In FIG. 4, a bridge rectifier (DB1) is shown.

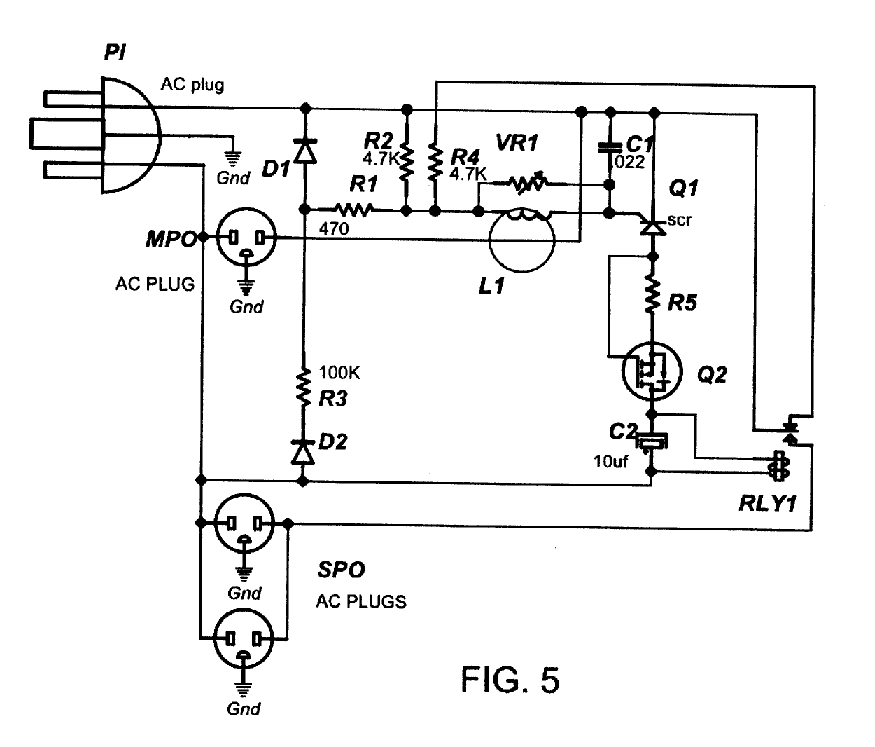

FIG. 5 shows a further embodiment of the apparatus of the present invention, which substantially corresponds to the embodiment of FIG. 2. However, in the apparatus in accordance with the embodiment of FIG. 5, a current regulating (limiting) device is formed with a resistor (R5) and an enhancement MOSFET (Q2). Combined with the voltage regulating diode (D1), this arrangement allows the claimed apparatus to be used at different input voltages without component changes.

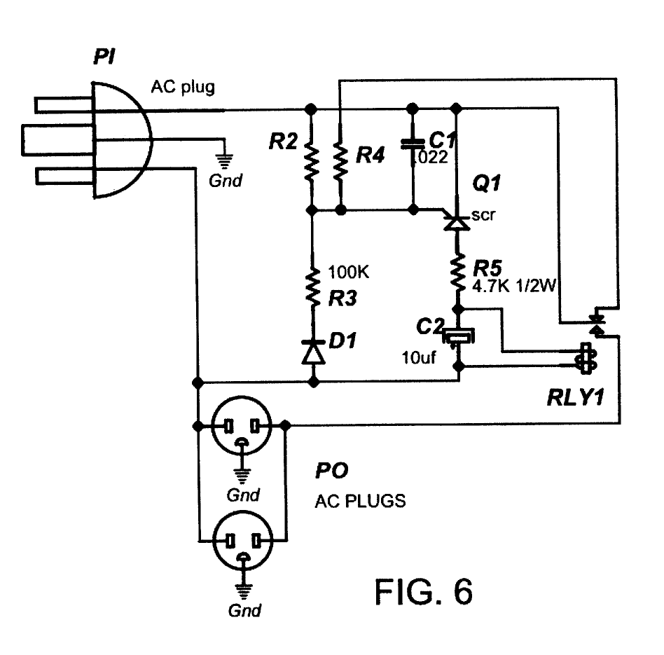

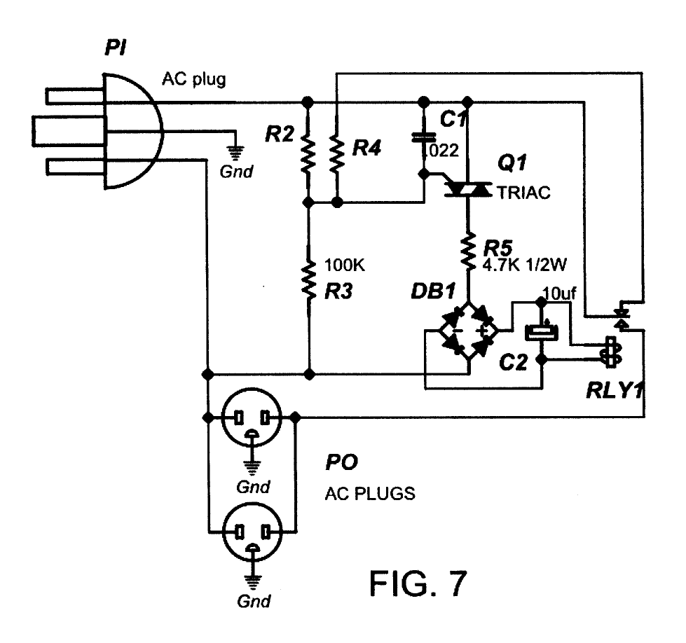

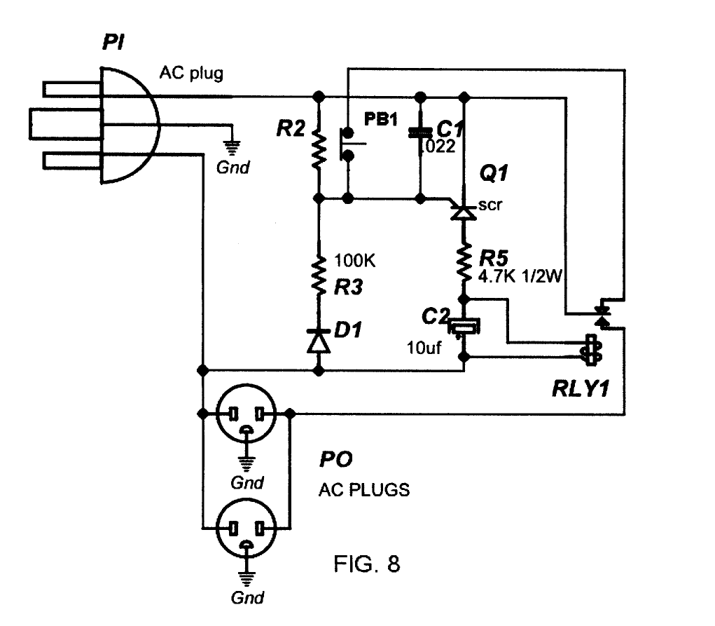

FIGS. 6 and 7 present another embodiment of the inventive apparatus, in which the primary outlet (MPO) and the current sensing coil, or transformer (L1-T1), have been removed. The threshold is determined by the voltage divider resistors (R2, R3). When the incoming line voltage is above a predetermined threshold, the executing means is turned on and when the incoming line voltage is below a predetermined threshold, the executing means is turned off. Again, the resistor (R4) is used to cause the “turn on” voltage to be higher than the “turn off” voltage for preventing oscillation of the relay (RLY1).

FIG. 8 shows another preferred embodiment of the present invention, which substantially corresponds to the embodiment of FIG. 6. However, in contrast to the embodiment of FIG. 6, the embodiment of FIG. 8 has the hysteresis resistor (R4) being replaced with a normally closed push-button (PB1). This allows the inventive apparatus to be manually re-settable.

It is to be understood that the apparatus in accordance with the present invention can be used on many different voltages by changing the resistor values, including, but not limited to, 100-, 120- and 220-VAC, for domestic and foreign use.

Alternatively, instead of the SCR (Q1) transistors, other switching devices may be used. Likewise, separate diodes can be used instead of the diode bridges. The reference diodes also can be replaced by any voltage reference device.

It will be understood that each of the elements described above, or two or more together, may also find a useful application in other types of constructions differing from the types described above.

While only several embodiments of the present invention have been shown and described, it will be obvious to those skilled in the art that many modifications may be made to the present invention without departing from the spirit and scope thereof.

What is claimed is:

1. Apparatus for controlling electrical power distribution between a primary device and at least one secondary device, comprising:
a power input connectable to a power source for receiving electrical current from the power source;
a primary power output connectable to a primary device for supplying the electrical current received by said power input to the primary device;
at least one secondary power output connectable to at least one secondary device for supplying the electrical current received by said power input to said at least one secondary device;
first means for sensing when a current level of the electrical current falls below a predetermined first threshold level in response to the primary device being deactivated;
second means for sensing when the current level of the electrical current rises above a predetermined second threshold level in response to the primary device being activated; and,
executing means connected with said first means for sensing and being operable for interpreting the electrical current to said at least one secondary device when said first means for sensing senses that the current level of the electrical current has fallen below said predetermined first threshold level and said executing means being connected with said second means for sensing and being operable for supplying the electrical current to said at least one secondary device when said second means for sensing senses that the current level of the electrical current has risen above said predetermined second threshold level.

2. The apparatus for controlling electrical power distribution between a primary device and at least one secondary device according to claim 1, wherein said first means for sensing and said second means for sensing are integrated into a single sensing device.

3. The apparatus for controlling electrical power distribution between a primary device and at least one secondary device according to claim 1, wherein said first means for sensing and said second means for sensing comprise at least two separate sensing devices.

4. The apparatus for controlling electrical power distribution between a primary device and at least one secondary device according to claim 1, further comprising low current operating means for increasing voltage received from the power source for triggering said executing means.

5. The apparatus for controlling electrical power distribution between a primary device and at least one secondary device according to claim 4, wherein said low current operating means includes a voltage reference for preventing a change in the current level for triggering said executed means to be effected by a change in the voltage received from the power source.

6. The apparatus for controlling electrical power distribution between a primary device and at least one secondary device according to claim 5, wherein said executing means includes a current regulator that is operable with said voltage reference for allowing said apparatus to be operable irrespective of incoming line voltage received from the power source.

7. The apparatus for controlling electrical power distribution between a primary device and at least one secondary device according to claim 1, wherein said executing means includes a DC reply.

8. Apparatus for controlling electrical power distribution between a primary device and at least one secondary device, comprising:
a power input connectable to a power source for receiving electrical current and supplying incoming line voltage from the power source to a primary device;
at least one secondary power output connectable to at least one secondary device for supplying the electrical current and the incoming line voltage received by said power input to said at least one secondary device; and,
executing means being operable for interpreting the electrical current to said at least one secondary device when a current level of the electrical current has fallen below a first threshold level and said executing means being operable for supplying the electrical current to said at least one secondary device when the current level of the electrical current has risen above a second threshold level, said first threshold level and said second threshold level being determined by the incoming line voltage.

9. The apparatus for controlling electrical power distribution between a primary device and at least one secondary device according to claim 8, further comprising low current operating means for increasing voltage received from the power source for triggering said executing means.

10. Apparatus for controlling one or more electrical power distribution devices, comprising:
a power input connectable to a power source for receiving electrical current and supplying incoming line voltage from the power source to least one power output connectable to at least one electrical device for supplying the electrical current received by said power input to said at least one electrical device;
first means for sensing when a voltage level of the incoming line voltage falls below a predetermined first threshold level in response to incoming electrical power from the power source is below a predetermined normal operational level;
second means for sensing when the voltage level of the incoming line voltage rises above a predetermined second threshold level in response to the incoming electrical power from the power source is at least substantially equal to the predetermined normal operational level; and,
executing means connected with said first means for sensing and being operable for interpreting the electrical current to said at least one electrical device when said first means for sensing senses that the incoming electrical power from the power source has fallen below said predetermined first threshold level and said executing means being connected with said second means for sensing and being operable for supplying the electrical current to said at least one electrical device when said second means for sensing senses that the incoming electrical power has risen above said predetermined second threshold level.

11. The apparatus for controlling one or more electrical power distribution devices according to claim 10, wherein said first means for sensing and said second means for sensing are integrated into a single sensing device.

12. The apparatus for controlling one or more electrical power distribution devices according to claim 10, wherein said first means for sensing and said second means for sensing comprise at least two separate sensing devices.

13. Apparatus for controlling electrical power distribution between a computer and at least one peripheral device for the computer, comprising:
a computer;
a power input for said computer connectable to a power source for receiving electrical current from the power source;
a primary power output connectable to said computer for supplying the electrical current received by said power input to said computer;
at least one peripheral device for said computer connectable to said computer;
at least one secondary power output for said computer connectable to at least one peripheral device for supplying the electrical current received by said power input to said at least one peripheral device;
first means for sensing when a current level of the electrical current falls below a predetermined first threshold level in response to said computer being deactivated;
second means for sensing when the current level of the electrical current rises above a predetermined second threshold level in response to said computer being activated; and,
executing means connected with said first means for sensing and being operable for interpreting the electrical current to said at least one peripheral device when said first means for sensing senses that the current level of the electrical current has fallen below said predetermined first threshold level and said executing means being connected with said second means for sensing and being operable for supplying the electrical current to said at least one peripheral device when said second means for sensing senses that the current level of the electrical current has risen above said predetermined second threshold level.

14. The apparatus for controlling electrical power distribution between a computer and at least one peripheral device for the computer according to claim 13, wherein said first means for sensing and said second means for sensing are integrated into a single sensing device.

15. The apparatus for controlling electrical power distribution between a computer and at least one peripheral device for the computer according to claim 13, wherein said first means for sensing and said second means for sensing comprise at least two separate sensing devices.

16. The apparatus for controlling electrical power distribution between a computer and at least one peripheral device for the computer according to claim 13, wherein said computer is a personal computer.

17. The apparatus for controlling electrical power distribution between a computer and at least one peripheral device for the computer according to claim 13, further comprising low current operating means for increasing voltage received from the power source for triggering said executing means.

18. The apparatus for controlling electrical power distribution between a computer and at least one peripheral device for the computer according to claim 17, wherein said low current operating means includes a voltage reference for preventing a change in the current level for triggering said executed means to be effected by a change in the voltage received from the power source.

19. The apparatus for controlling electrical power distribution between a computer and at least one peripheral device for the computer according to claim 18, wherein said executing means includes a current regulator that is operable with said voltage reference for allowing said apparatus to be operable irrespective of incoming line voltage received from the power source.

20. Apparatus for controlling electrical power distribution between a computer and at least one peripheral device for the computer, comprising:
a computer;
a power input connectable to a power source for receiving electrical current and supplying incoming line voltage from the power source to said computer;
at least one peripheral device for said computer;
at least one secondary power output connectable to said at least one peripheral device for supplying the electrical current and the incoming line voltage received by said power input to said at least one peripheral device; and,
executing means being operable for interpreting the electrical current to said at least one peripheral device when a current level of the electrical current has fallen below a first threshold level and said executing means being operable for supplying the electrical current to said at least one peripheral device when the current level of the electrical current has risen above a second threshold level, said first threshold level and said second threshold level being determined by the incoming line voltage.
